(19) United States
(12) Patent Application Publication
(10) Pub. No.: US 2025/0150150 A1
(43) Pub. Date: May 8, 2025

(54) MAC-CE UPDATE PER-TRP BFD RS SET

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 18/834,130

(22) PCT Filed: Mar. 15, 2022
(86) PCT No.: PCT/CN2022/080827

§ 371 Date: Jul. 29, 2024

(51) Int. Cl. H04B 7/06; H04L 5/00

(52) U.S. Cl. CPC H04B 7/06964; H04B 7/0626; H04L 5/0055

(57) ABSTRACT

Apparatus, methods, and computer program products for performing operations based on TA timer expiration are provided. An example method may include receiving, from a network entity, a first TAG configuration associated with a first TRP associated with the network entity. The example method may further include receiving, from the network entity, a second TAG configuration associated with a second TRP associated with the network entity, the first TAG configuration and the second TAG configuration being associated with a BWP or a CC, the first TAG configuration being associated with a first time alignment timer and the second TAG configuration being associated with a second time alignment timer. The example method may further include performing one or more timer expiration operations for a serving cell based on at least one of the first time alignment timer or the second time alignment timer.

### TECHNICAL FIELD

The present disclosure relates generally to communication systems, and more particularly, to wireless communication systems with beam failure detection (BFD).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus may include a memory and at least one processor coupled to the memory. The memory and the at least one processor coupled to the memory may be configured to receive, from a network entity associated with a set of transmission reception points (TRPs), a first set of beam failure detection (BFD) reference signal (RS) (BFD RS), each BFD RS in the first set of BFD RS correspond with one TRP in the set of TRPs, the first set of BFD RS being received based on radio resource control (RRC), a first medium access control (MAC) control element (MAC-CE), or derived based on downlink control information (DCI). The memory and the at least one processor coupled to the memory may be further configured to receive, from the network entity, a second MAC-CE indicating a second set of BFD RS, each BFD RS in the second set of BFD RS correspond with the one TRP in set of TRPs.

In another aspect of the disclosure, a method, a computer-readable medium, and an apparatus at a network entity associated with a set of transmission reception points (TRPs) are provided. The apparatus may include a memory and at least one processor coupled to the memory. The memory and the at least one processor coupled to the memory may be configured to transmit, for a user equipment (UE), a first set of beam failure detection (BFD) reference signal (RS) (BFD RS), each BFD RS in the first set of BFD RS correspond with one TRP in the set of TRPs, the first set of BFD RS being received based on radio resource control (RRC), a first medium access control (MAC) control element (MAC-CE), or derived based on downlink control information (DCI). The memory and the at least one processor coupled to the memory may be further configured to transmit, a second MAC-CE indicating a second set of BFD RS, each BFD RS in the second set of BFD RS correspond with the one TRP in set of TRPs.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network, in accordance with various aspects of the present disclosure.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network, in accordance with various aspects of the present disclosure.

FIG. 4 is a diagram illustrating example communications between a base station and

a UE for beamforming, in accordance with various aspects of the present disclosure.

FIG. 5 is a diagram illustrating example aspects of a BFD and BFR procedure, in accordance with various aspects of the present disclosure.

FIG. 6 is a diagram illustrating example communications between a network entity and a UE, in accordance with various aspects of the present disclosure.

FIG. 7 is a flowchart of a method of wireless communication, in accordance with various aspects of the present disclosure.

FIG. 8 is a flowchart of a method of wireless communication, in accordance with various aspects of the present disclosure.

FIG. 9 is a flowchart of a method of wireless communication, in accordance with various aspects of the present disclosure.

FIG. 10 is a diagram illustrating an example of a hardware implementation for an example apparatus and/or network entity, in accordance with various aspects of the present disclosure.

FIG. 11 is a diagram illustrating an example of a hardware implementation for an example network entity, in accordance with various aspects of the present disclosure.

### DETAILED DESCRIPTION

A wireless device may include M-TRP. Each TRP may include different RF modules having a shared hardware and/or software controller. Each TRP may have separate RF and digital processing. Each TRP may also perform separate baseband processing. Each TRP may include a different antenna panel or a different set of antenna elements of a wireless device. The TRPs of the wireless device may be physically separated. Example aspects provided herein may provide explicit MAC-CE update for BFD-RS in M-TRP BFR, which may facilitate more efficient M-TRP operations.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

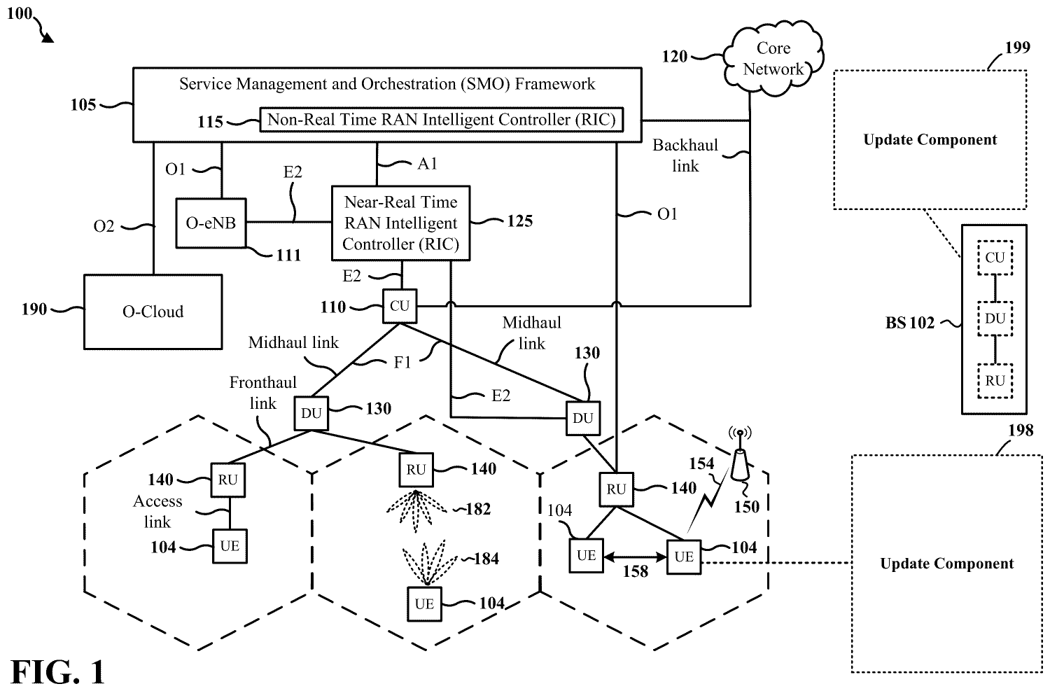

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units.

Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHZ), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include an update component 198. In some aspects, the update component 198 may be configured to receive, from a network entity associated with a set of TRPs, a first set of BFD RS, each BFD RS in the first set of BFD RS correspond with one TRP in the set of TRPs, the first set of BFD RS being received based on RRC, a first MAC-CE, or derived based on DCI. In some aspects, the update component 198 may be further configured to receive, from the network entity, a second MAC-CE indicating a second set of BFD RS, each BFD RS in the second set of BFD RS correspond with the one TRP in set of TRPs. The TRP identity associated a set of BFD RSs may be one to one mapped with other certain identity, such as control resource set pool index, control resource set list, or the set ID of BFD RS.

In certain aspects, the base station 102 may include an update component 199. In some aspects, the update component 199 may be configured to transmit, for a UE, a first set of BFD RS, each BFD RS in the first set of BFD RS correspond with one TRP in the set of TRPs, the first set of BFD RS being received based on RRC, a first MAC-CE, or derived based on DCI. In some aspects, the update component 199 may be further configured to transmit, a second MAC-CE indicating a second set of BFD RS, each BFD RS in the second set of BFD RS correspond with the one TRP in set of TRPs.

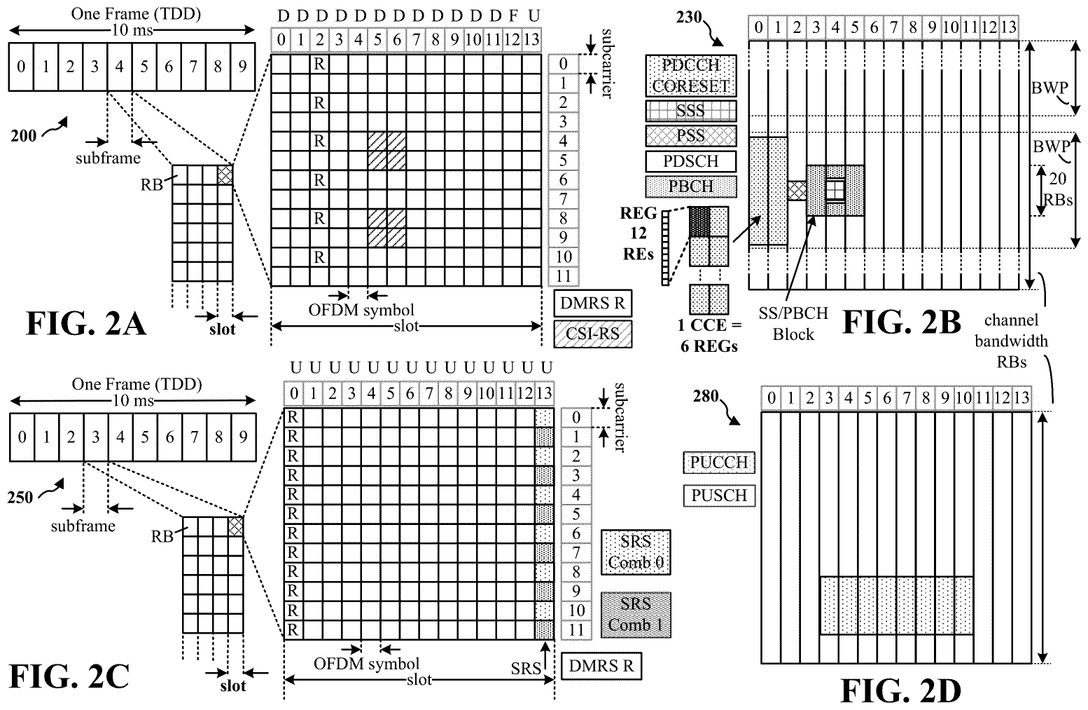

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

TABLE 1

| | SCS | Cyclic |
|---|---|---|
| μ | Δf = 2^{μ} · 15[kHz] | prefix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

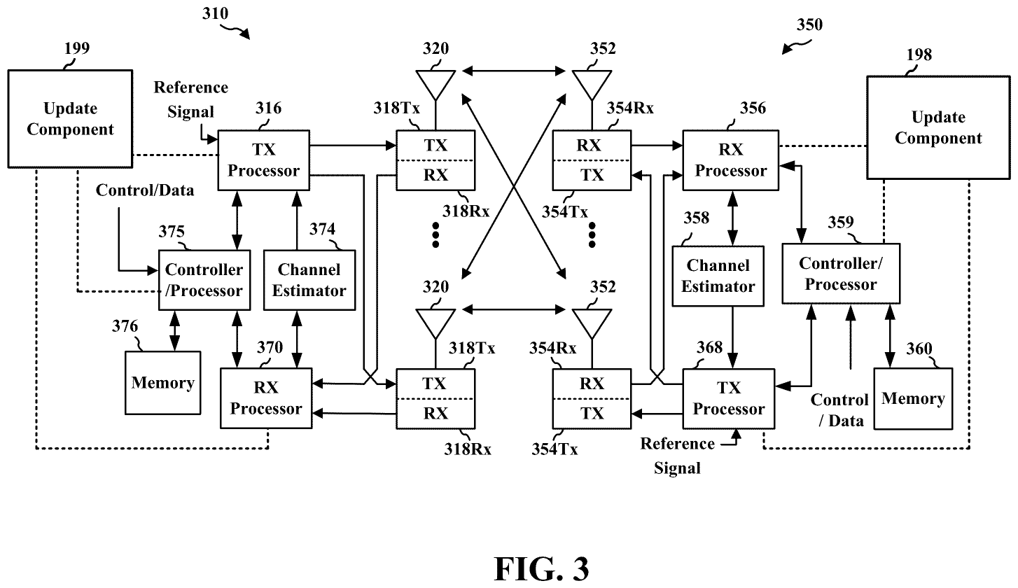

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality. The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with update component 198 of FIG. 1.

At least one of the TX processor 316, the RX processor 370, and the controller/processor 375 may be configured to perform aspects in connection with update component 199 of FIG. 1.

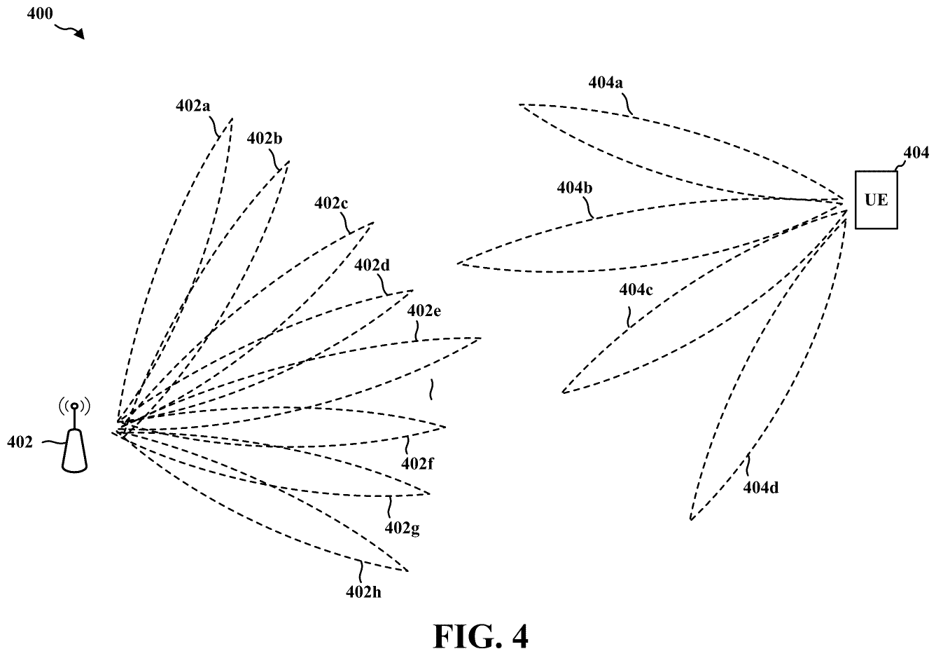

As described in connection with example 400 in FIG. 4, the base station 402 and UE 404 may communicate over active data/control beams both for DL communication and UL communication. The base station and/or UE may switch to a new beam direction using beam failure recovery procedures. Referring to FIG. 4, the base station 402 may transmit a beamformed signal to the UE 404 in one or more of the directions 402a, 402b, 402c, 402d, 402e, 402f, 402g, 402h. The UE 404 may receive the beamformed signal from the base station 402 in one or more receive directions 404a, 404b, 404c, 404d. The UE 404 may also transmit a beamformed signal to the base station 402 in one or more of the directions 404a-404d. The base station 402 may receive the beamformed signal from the UE 404 in one or more of the receive directions 402a-402h. The base station 402/UE 404 may perform beam training to determine the best receive and transmit directions for each of the base station 402/UE 404. The transmit and receive directions for the base station 402 may or may not be the same. The transmit and receive directions for the UE 404 may or may not be the same.

In response to different conditions, the UE 404 may determine to switch beams, e.g., between beams 402a-402h. The beam at the UE 404 may be used for reception of downlink communication and/or transmission of uplink communication. In some examples, the base station 402 may send a transmission that triggers a beam switch by the UE 404. For example, the base station 402 may indicate a transmission configuration indication (TCI) state change, and in response, the UE 404 may switch to a new beam for the new TCI state of the base station 402. In some instances, a UE may receive a signal, from a base station, configured to trigger a transmission configuration indication (TCI) state change via, for example, a MAC control element (CE) command. The TCI state change may cause the UE to find the best UE receive beam corresponding to the TCI state from the base station, and switch to such beam. Switching beams may allow for enhanced or improved connection between the UE and the base station by ensuring that the transmitter and receiver use the same configured set of beams for communication. In some aspects, a single MAC-CE command may be sent by the base station to trigger the changing of the TCI state on multiple CCs.

A TCI state may include quasi co-location (QCL) information that the UE can use to derive timing/frequency error and/or transmission/reception spatial filtering for transmitting/receiving a signal. Two antenna ports are said to be quasi co-located if properties of the channel over which a symbol on one antenna port is conveyed can be inferred from the channel over which a symbol on the other antenna port is conveyed. The base station may indicate a TCI state to the UE as a transmission configuration that indicates QCL relationships between one signal (e.g., a reference signal) and the signal to be transmitted/received. For example, a TCI state may indicate a QCL relationship between DL RSs in one RS set and PDSCH/PDCCH DM-RS ports. TCI states can provide information about different beam selections for the UE to use for transmitting/receiving various signals. Under a unified TCI framework, different types of common TCI states may be indicated. For example, a type 1 TCI may be a joint DL/UL common TCI state to indicate a common beam for at least one DL channel or RS and at least one UL channel or RS. A type 2 TCI may be a separate DL (e.g., separate from UL) common TCI state to indicate a common beam for more than one DL channel or RS. A type 3 TCI may be a separate UL common TCI state to indicate a common beam for more than one UL channel/RS. A type 4 TCI may be a separate DL single channel or RS TCI state to indicate a beam for a single DL channel or RS. A type 5 TCI may be a separate UL single channel or RS TCI state to indicate a beam for a single UL channel or RS. A type 6 TCI may include UL spatial relation information (e.g., such as sounding reference signal (SRS) resource indicator (SRI)) to indicate a beam for a single UL channel or RS. An example RS may be an SSB, a tracking reference signal (TRS) and associated CSI-RS for tracking, a CSI-RS for beam management, a CSI-RS for CQI management, a DM-RS associated with non-UE-dedicated reception on PDSCH and a subset (which may be a full set) of control resource sets (CORESETs), or the like. A TCI state may be defined to represent at least one source RS to provide a reference (e.g., UE assumption) for determining quasi-co-location (QCL) or spatial filters. For example, a TCI state may define a QCL assumption between a source RS and a target RS.

Before receiving a TCI state, a UE may assume that the antenna ports of one DM-RS port group of a PDSCH are spatially quasi-co-located (QCLed) with an SSB determined in the initial access procedure with respect to one or more of: a Doppler shift, a Doppler spread, an average delay, a delay spread, a set of spatial Rx parameters, or the like. After receiving the new TCI state, the UE may assume that the antenna ports of one DM-RS port group of a PDSCH of a serving cell are QCLed with the RS(s) in the RS set with respect to the QCL type parameter(s) given by the indicated TCI state. Regarding the QCL types, QCL type A may include the Doppler shift, the Doppler spread, the average delay, and the delay spread; QCL type B may include the Doppler shift and the Doppler spread; QCL type C may include the Doppler shift and the average delay; and QCL type D may include the spatial Rx parameters (e.g., associated with beam information such as beamforming properties for finding a beam).

In another aspect, a spatial relation change, such as a spatial relation update, may trigger the UE to switch beams. Beamforming may be applied to uplink channels, such as but not limited to PUCCH. Beamforming may be based on configuring one or more spatial relations between the uplink and downlink signals. Spatial relation indicates that a UE may transmit the uplink signal using the same beam as it used for receiving the corresponding downlink signal.

In another aspect, the base station 402 may change a pathloss reference signal configuration that the UE uses to determine power control for uplink transmissions, such as SRS, PUCCH, and/or PUSCH. In response to the change in the pathloss reference signal, the UE 404 may determine to switch to a new beam.

A UE may monitor the quality of the beams that it uses for communication with a base station. For example, a UE may monitor a quality of a signal received via reception beam(s). A beam failure detection (BFD) procedure may be used to identify problems in beam quality and a beam recovery procedure (BFR) may be used when a beam failure is detected. The BFD procedure may indicate whether a link for a particular beam is in-sync or out-of-sync, which may be referred to as a beam failure instance. For monitoring active link performances, a UE may perform measurements of at least one signal, e.g., reference signals (RS), for beam failure detection. The RS for BFD may be also referred to as BFD-RS. The measurements may include deriving a metric similar to a signal to noise and interference ratio (SINR) for the signal, or RSRP strength or block error rate (BLER) of a reference control channel chosen by base station and/or implicitly derived by UE based on the existing RRC configuration. The BFD-RS may include any of CSI-RS, a synchronization signal block (SSB), or other RS for time and/or frequency tracking, or the like. The UE may receive an indication of reference signal resources to be used to measure beam quality in connection with BFD. The UE may monitor the reference signal(s) and determine the signal quality, e.g., reference signal received power (RSRP) for the reference signal. In some cases, the UE may determine a configured metric such as block error rate (BLER) for a reference signal. The measurement(s) may indicate the UE's ability to decode a transmission, e.g., a DL control transmission from the base station.

Thresholds may be defined in tracking the radio link conditions, the threshold(s) may correspond to an RSRP, a BLER, etc. that indicates an in-sync condition and/or an out-of-sync condition of the radio link. An “out-of-sync” condition may indicate that the radio link condition is poor, and an “in-sync” condition may indicate that the radio link condition is acceptable, and the UE is likely to receive a transmission transmitted on the radio link. An Out-of-Sync condition may be declared when a block error rate for the radio link falls below a threshold over a specified time interval, e.g., a 200 ms time interval. The Out-of-Sync condition may also be referred to as a beam failure instance (BFI). The UE may determine a BFI indicator at every occasion of BFD-RS. An in-sync condition may be declared when a block error rate for the radio link is better than a threshold over a second, specified time interval, e.g., over 100 ms time interval.

The thresholds and time intervals used to determine the in-sync condition and out-of-sync condition may be the same or may be different from each other. If the UE receives a threshold number of consecutive out-of-sync measurements, which may be referred to as beam failure instances (BFIs) over a period of time, the UE may identify a beam failure detection (BFD) and may declare a beam failure to the network and accordingly initiate a beam failure recovery (BFR) procedure. The BFR procedure may include notifying the network about the beam failure and accordingly initiate a beam switching procedure via medium access control (MAC) control element (MAC-CE) or downlink control information (DCI) or beam recovery procedure via random access channel (RACH).

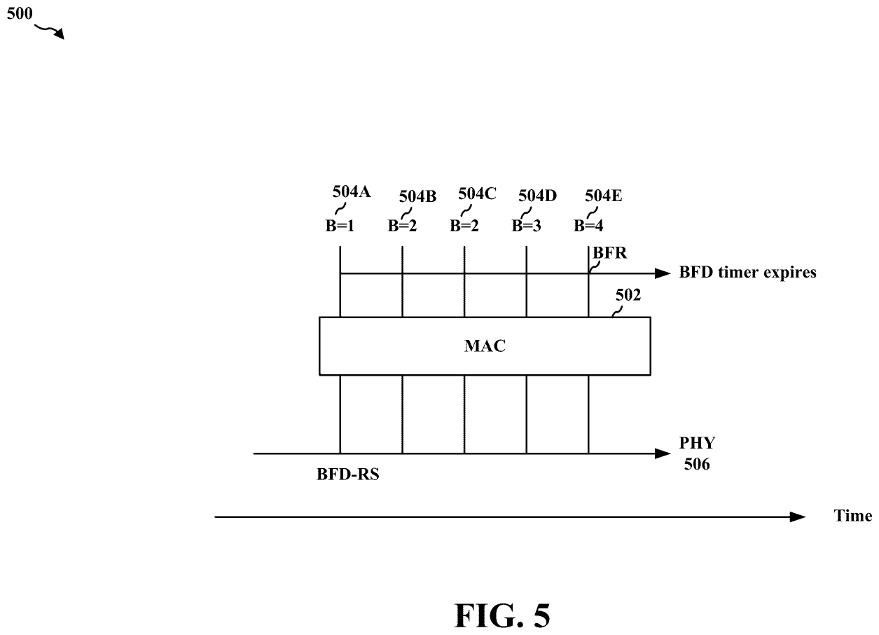

For example, FIG. 5 is a diagram 500 illustrating example aspects of a BFD and BFR procedure. A medium access control (MAC) entity 502 at a UE may receive BFD-RS from a physical (PHY) entity 506 at the UE. The BFD-RS may be transmitted from the network and received by the PHY entity 506 at the UE. Upon receiving a first BFD-RS 504A, the UE may identify whether BFI occurs based on the various measurements previously described. Upon identifying an occurrence of a BFI upon receiving the first BFD-RS 504A, the UE may initiate a BFD timer with a defined duration. The UE may keep identifying additional BFIs based on received BFD-RS 504B, 504C, 504D, and 504E. Over the period of time until the BFD timer with the defined duration expires, if a total BFI count reaches a threshold (e.g., a maxCount threshold), the UE may declare a beam failure and may accordingly initiate a BFR procedure. In the example illustrated in FIG. 5, the threshold may be 4. If the BFD timer expires before the total BFI count reaches the threshold, the UE may not declare beam failure and may reset BFI counts to zero and reset the BFD timer.

In some wireless communication systems, a UE may be provided, for each bandwidth part (BWP) of a serving cell, a set q0 of periodic CSI-RS resource configuration indexes by a parameter representing beam failure detection resources (e.g., failureDetectionResources) and a set q1 of periodic CSI-RS resource configuration indexes and/or SS/PBCH block indexes by a parameter representing candidate beam RS (e.g., candidateBeamRSList, candidateBeamRSListExt-r16, or candidateBeamRSSCellList-r16) for radio link quality measurements on the BWP of the serving cell. If the UE is not provided q0 by the parameter representing beam failure detection resources (e.g., failureDetectionResources) or another parameter representing a list of resources for beam failure detection (e.g., beamFailureDetectionResourceList) for a BWP of the serving cell, the UE may determine the set q0 to include periodic CSI-RS resource configuration indexes with same values as the RS indexes in the RS sets indicated by TCI state (e.g., represented by TCI-State parameter) for respective CORESETs that the UE uses for monitoring PDCCH. If there are two RS indexes in a TCI state, the set q0 may include RS indexes with QCL Type D configuration for the corresponding TCI states. The UE may expect the set q0 to include up to two RS indexes.

A wireless device may include M-TRP. Each TRP may include different RF modules having a shared hardware and/or software controller. Each TRP may have separate RF and digital processing. Each TRP may also perform separate baseband processing. Each TRP may include a different antenna panel or a different set of antenna elements of a wireless device. The TRPs of the wireless device may be physically separated. For example, TRPs on a wireless device of a vehicle may be located at different locations of the vehicle. Front and rear antenna panels on a vehicle may be separated by 3 meters, 4 meters, or the like. The spacing between TRPs may vary based on the size of a vehicle and/or the number of TRPs associated with the vehicle. Each of the TRPs may experience a channel differently (e.g., experience a different channel quality) due to the difference physical location, the distance between the TRPs, different line-of-sight (LOS) characteristics (e.g., a LOS channel in comparison to a non-LOS (NLOS) channel), blocking/obstructions, interference from other transmissions, among other reasons.

In some wireless communication systems, M-TRP BFR may be configured to facilitate M-TRP operations. In some aspects, for M-TRP BFR, one or more, such as two, BFD-RS sets per BWP, and up to N resources per BFD-RS set may be supported, N being a positive integer. In some aspects, number of BFD RSs across all BFD-RS sets per DL BWP may be a fixed maximum value or flexible (e.g., greater than 1) based on UE capability. In some aspects, an association between a BFD-RS set on SpCell (e.g., primary cell of a master or secondary cell group) and a PUCCH-scheduling request (SR) resource or SR configuration for per TRP BFR may be configured. In some aspects, an association between a BFD-RS set on secondary cell (SCell) and a PUCCH-SR resource or SR configuration for per TRP BFR may also be configured. In some aspects, in multiple DCI (M-DCI) operations for UEs with one activated TCI state per CORESET, BFD-RS set k (k=0, 1 or other positive integers) may be derived based on X TCI of CORESETs with a CORESET pool index (e.g., represented by CORESETPoolIndex) equal to k, X may be a positive integer. In some aspects, a value of X may be based on UE capability or fixed. In some aspects, TCI selection rule when the number of CORESETs with CORESETPoolIndex=k exceeds X may be defined (e.g., based on radio link monitoring (RLM) RS selection rule).

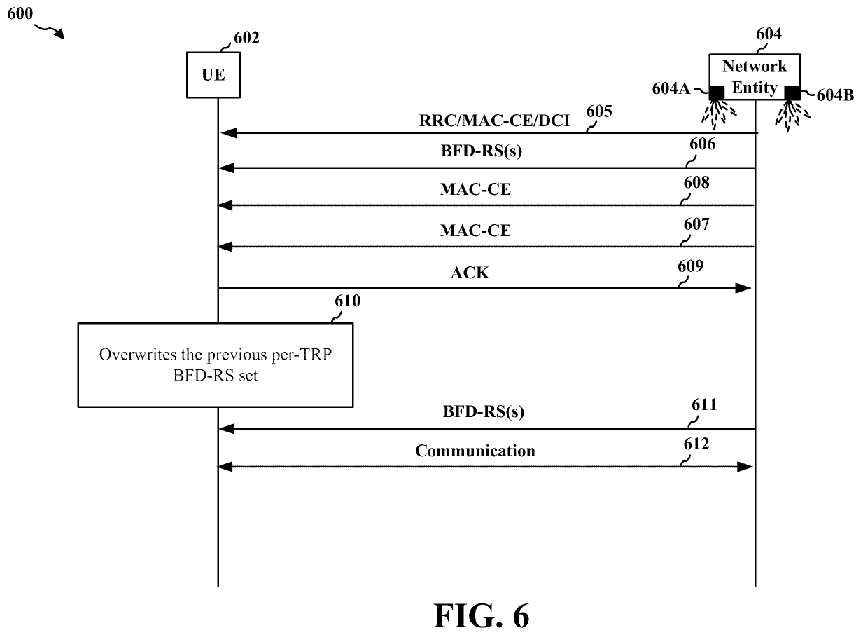

Example aspects provided herein may provide explicit MAC-CE update for BFD-RS in M-TRP BFR, which may facilitate more efficient M-TRP operations. FIG. 6 is a diagram 600 illustrating example communications between a network entity 604 and a UE 602. The network entity 604 may be a network node. A network node may be implemented as an aggregated base station, a component of a disaggregated base station, an integrated access and backhaul (IAB) node, a relay node, a sidelink node, or the like. A network entity can be implemented in an aggregated or monolithic base station architecture, or alternatively, in a disaggregated base station architecture, and may include one or more of a CU, a DU, a RU, a Near-Real Time (Near-RT) RAN Intelligent Controller (RIC), or a Non-Real Time (Non-RT) RIC. In some aspects, the network entity 604 may be associated with (e.g., associated with a base station that may include) a first TRP 604A and a second TRP 604B.

In some aspects, the UE 602 may be configured with a first set of BFD RS 606 from the network entity 604. In some aspects, the first set of BFD RS 606 may be configured based on RRC, e.g., 605. In some aspects, the first set of BFD RS 606 may be configured based on a MAC-CE, e.g., 605. In some aspects, the first set of BFD RS 606 may be derived based on the CORESETs where the UE 602 is to receive DCI, e.g., 605, transmitted from the network entity 604 to the UE 602. In some aspects, the first set of BFD RS 606 may be a per-TRP BFD-RS set for a cell. Based on the information received in the RRC, MAC-CE, and/or DCI, e.g., at 605, the UE 602 may monitor for and/or measure the indicated BFD-RS(s) 606 for each of the TRPs. For example, the UE may measure one or more BFD-RS indicated for the TRP 604A and one or more BFD-RS indicated for the TRP 604B. Although only two TRPs are illustrated, the aspects presented herein may be applied to more than two TRPs.

In some aspects, the UE 602 may receive a MAC-CE 608 updating the configured BFD-RS (e.g., the first set of BFD RS 606) with a second set of BFD-RS. In some aspects, the MAC-CE 608 may be a MAC-CE for updating an explicit per-TRP BFD-RS set for a cell and may be indicated with the following information for the second set of BFD-RS a cell: 1) BFD RS set's cell ID, and BWP ID, 2) BFD RS set Indication: which may be a BFR RS set ID, a TRP ID, or a CORESET pool index, or 3) a number of BFD sets for the cell may be indicated explicitly or implicitly. In some aspects, BFD RS ID, and at least one of cell ID or BWP ID for each BFD RS in the BFD RS set may be indicated in the MAC-CE 608. In some other aspects, BFD RS ID for each BFD RS in the BFD RS set may be indicated in the MAC-CE 608. In some aspects, the MAC-CE 608 may indicate local resource ID from a configured BFD RS pool as BFD RS ID. For example, if a configured BFD RS pool has a number of 16 BFD RSs, the BFD RS may have a local resource ID from 0 to 15.

In some aspects, after receiving the MAC-CE 608 updating the per-TRP BFD-RS set for a cell, the UE 602 may overwrite the previous per-TRP BFD-RS set (first set of BFD-RS 606). Overwriting may mean that the UE stops monitoring for and measuring the previously indicated per-TRP BFD-RS set and begins monitoring for and measuring the updated per-TRP BFD-RS set 611 indicated in the MAC-CE 608. For example, the UE may measure one or more BFD-RS in the BFD-RS set 611 indicated in the MAC-CE 608 for the TRP 604A and one or more BFD-RS in the BFD-RS set 611 indicated in the MAC-CE 608 for the TRP 604B. In some aspects, after receiving the MAC-CE 608 updating the per-TRP BFD-RS set for a cell, the UE 602 may transmit an acknowledgment (ACK) 609 to the network entity 604 acknowledging the MAC-CE 608. In some aspects, the UE 602 may apply the second set of BFD RS after a time period after transmitting the ACK 609. For example, the time period may be 3 milliseconds, or a predetermined number of slots.

In some aspects, the MAC-CE 608 updating the per-TRP explicit BFD-RS sets may be associated with multiple cells. For example, the UE 608 may be indicated with the existence of the second BFD RS set to a cell in multiple cells. In some aspects, the UE 608 may be indicated with the existence of the second BFD RS set to a cell in multiple cells based on an existence indication or a number of BFD sets information indicated for a cell. In some aspects, MAC-CE 608 updating the per-TRP explicit BFD-RS sets may be associated with a single cell per MAC-CE. In some aspects, a format of the MAC-CE 608 may be based on the table below:

TABLE 2

| BFD RS | Cell ID for | | |
|---|---|---|---|
| Set ID | BFD RS sets | | BWP ID |
| T0 | R | Resource ID0 | |
| . . . | | | |

| | | |
|---|---|---|
| TN-1 | R | Resource IDN-1 |

In some aspects, each row of Table 2 may correspond with one Octet (e.g., 8 bits). A BFD RS set ID may correspond with one cell ID (e.g., 5 bits and indicate 0 to 31) and may correspond with one BWP ID (e.g., 2 bits and indicate 0 to 3). The resource ID 0 to N−1 may correspond with a number of N BFD RS resources in the BFD RS set. The UE may be able to understand how many resources are in the BFD RS set. T0 to TN−1 may provide a next resource indication. For example, if T0 is 0, the next resource in the next octet may be not present, or not belonging to the same BFD RS set. If T0 is 1 may indicate the next resource in the next octet may be present and belonging to the same BFD RS set. In some aspects, R may be a reserved field if the BFD RS ID, i.e., resource ID is of 6 bits. In some aspects, if the BFD RS ID may be a periodic CSI-RS ID and may be of 7 bits, the field for R bit may be not included, and an octet may include the fields of Tn and Resource ID n, n=0, . . . . N−1.

In some aspects, a format of the MAC-CE 608 may be based on the table below:

TABLE 3

| R | Cell ID for BFD RS sets | | BWP ID |
|---|---|---|---|
| T0 | BFD RS | Resource ID0 | |
| | SET ID | | |
| . . . | | | |
| TN-1 | BFD RS | Resource IDN-1 | |
| | SET ID | | |

In the example illustrated in table 3, the one or more BFD RS set IDs may be associated with the cell ID for the BFD RS sets (e.g., 5 bits and indicate 0 to 31) and the BWP ID (e.g., 2 bits and indicate 0 to 3). In some aspects, each row of Table 3 may correspond with one Octet (e.g., 8 bits). The resource ID 0 to N−1 may correspond with a number of N BFD RS resources, where each BFD RS resource may correspond to a BFD RS set with the BFD set ID indicated in the same octet as the BFD RS resource. The BFD RS SET ID may be 0 or 1. The UE may be able to understand how many resources are in the BFD RS set. The BFD RS set ID may be associated with T0 to TN−1 and the resource ID. The fields T0 to TN−1 may be next resource indication. For example, if TO is 0, the next resource in the next octet may be not present for the cell. If TO is 1 may indicate the next resource in the next octet may be present for the cell.

In some aspects, a format of the MAC-CE 608 may be based on the table below:

TABLE 4

| BFD RS | | | | | | | |
|---|---|---|---|---|---|---|---|
| SET ID | Cell ID for BFD RS sets | | | | | BWP ID | |
| T7 | T6 | T5 | T4 | T3 | T2 | T1 | T0 |

. . .

| | | | | | | | |
|---|---|---|---|---|---|---|---|
| TN-1 | TN-2 | TN-3 | TN-4 | TN-5 | TN-6 | TN-7 | TN-8 |

As illustrated in Table 4, the BFD RS set ID may be associated with cell ID for BFD RS sets and BWP ID. Remainder of the MAC-CE may include a bitmap and each bit may correspond with a BFD RS resource configured within a pool. For example, there may be 16 BFD RS configured as one pool and a two Octet bitmap may represent the RSs in the pool. For example, if a bit is set to 1, the BFD RS corresponding to the bit is indicated for the BFD RS set.

In some aspects, in the MAC-CE 608 for updating an explicit per-TRP BFD-RS set for a cell or in a different MAC-CE 607, the UE 602 may be indicated with the following information for a cell: 1) candidate RS set indication; 2) candidate RS indication; or 3) existence of candidate RS set to a cell if multiple cells are reported in a single MAC-CE. In some aspects, the candidate RS set indication may include associated candidate RS set which may be implicit, candidate RS set, or BFD-RS set mapped with order. In some aspects, the candidate RS set indication may include candidate RS set ID (which may be explicitly the ID, 0, or 1). In some aspects, the candidate RS indication may indicate whether candidate RS is a CSI-RS or SSB. In some aspects, the candidate RS indication may indicate candidate RS ID and cell ID for each candidate RS. In some aspects, the candidate RS indication may indicate local resource ID from a configured candidate RS pool as candidate RS ID. In some aspects, the existence of candidate RS set to a cell if multiple cells are reported in a single MAC-CE may be indicated based on existence indication or the number of candidate sets information indicated for a cell. In some aspects, the network entity 604 and the UE 602 may exchange communication 612 based on the new BFD-RS configured by the MAC-CE 608.

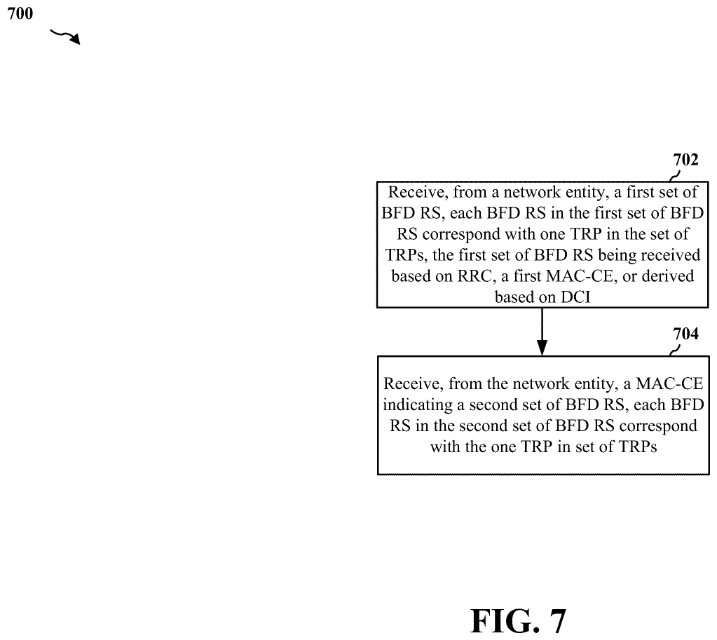

FIG. 7 is a flowchart 700 of a method of wireless communication. The method may be performed by a UE (e.g., the UE 104, the UE 602; the apparatus 1004).

At 702, the UE may receive, from a network entity associated with a set of TRPs, a first set of BFD RS, each BFD RS in the first set of BFD RS correspond with one TRP in the set of TRPs, the first set of BFD RS may be received based on RRC, a first MAC-CE, or derived based on DCI. For example, the UE 602 may receive, from a network entity 604 associated with a set of TRPs, a first set of BFD RS (e.g., 606), each BFD RS in the first set of BFD RS correspond with one TRP in the set of TRPs, the first set of BFD RS may be received based on RRC, a first MAC-CE, or derived based on DCI. In some aspects, 702 may be performed by update component 198.

At 704, the UE may receive, from the network entity, a second MAC-CE indicating a second set of BFD RS, each BFD RS in the second set of BFD RS may correspond with the one TRP in set of TRPs. For example, the UE 602 may receive, from the network entity, a second MAC-CE 608 indicating a second set of BFD RS, each BFD RS in the second set of BFD RS may correspond with the one TRP in set of TRPs. In some aspects, 704 may be performed by update component 198.

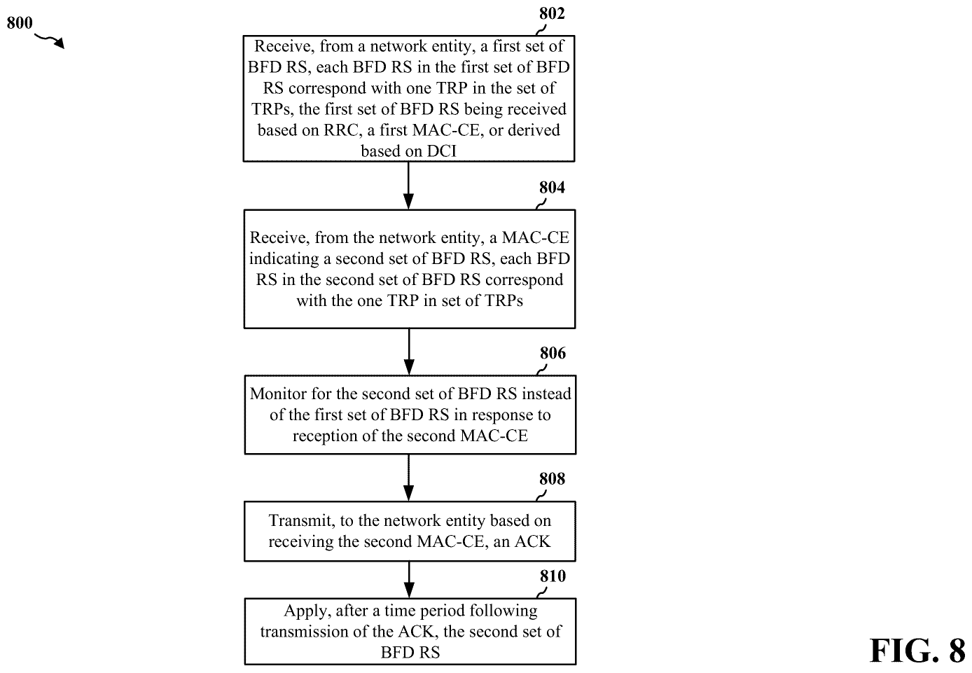

FIG. 8 is a flowchart 800 of a method of wireless communication. The method may be performed by a UE (e.g., the UE 104, the UE 602; the apparatus 1004).

At 802, the UE may receive, from a network entity associated with a set of TRPs, a first set of BFD RS, each BFD RS in the first set of BFD RS correspond with one TRP in the set of TRPs, the first set of BFD RS may be received based on RRC, a first MAC-CE, or derived based on DCI. For example, the UE 602 may receive, from a network entity 604 associated with a set of TRPs, a first set of BFD RS (e.g., 606), each BFD RS in the first set of BFD RS correspond with one TRP in the set of TRPs, the first set of BFD RS may be received based on RRC, a first MAC-CE, or derived based on DCI. In some aspects, 802 may be performed by update component 198.

At 804, the UE may receive, from the network entity, a second MAC-CE indicating a second set of BFD RS, each BFD RS in the second set of BFD RS may correspond with the one TRP in set of TRPs. For example, the UE 602 may receive, from the network entity, a second MAC-CE 608 indicating a second set of BFD RS, each BFD RS in the second set of BFD RS may correspond with the one TRP in set of TRPs. In some aspects, 804 may be performed by update component 198. In some aspects, the second MAC-CE is associated with a cell ID associated with the second set of BFD RS and a BWP ID. In some aspects, the second MAC-CE is associated with one or more BFR RS set IDs. In some aspects, the second MAC-CE further indicates at least one of a cell ID or a BWP ID for each BFD RS in the second set of BFD RS. In some aspects, the second MAC-CE further indicates a local resource ID from a configured BFD RS pool as BFD RS ID for each BFD RS in the second set of BFD RS. In some aspects, the second MAC-CE is associated with multiple cells associated with the network entity. In some aspects, the second MAC-CE further indicates that the second set of BFD RS is associated with a one cell in the multiple cells associated with the network entity. In some aspects, the second MAC-CE is associated with a single cell associated with the network entity. In some aspects, the second MAC-CE is associated with a candidate RS set indication representing a candidate RS set associated with the second set of BFD RS or one or more candidate RS IDs, the candidate RS set indication being included in the second MAC-CE or a third MAC-CE. In some aspects, the second MAC-CE is associated with a candidate RS indication representing whether each candidate RS in a set of candidate RS is a channel status information (CSI) reference signal (CSI RS) or a synchronization signal block (SSB) or representing candidate RS ID associated with each candidate RS in the set of candidate RS, the candidate RS indication being included in the second MAC-CE or a third MAC-CE. In some aspects, the second MAC-CE further indicates an existence of a candidate RS set associated with a cell associated with the second set of BFD RS.

At 806, the UE may monitor for the second set of BFD RS instead of the first set of BFD RS in response to reception of the second MAC-CE. For example, the UE 602 may monitor for the second set of BFD RS instead of the first set of BFD RS in response to reception of the second MAC-CE after overwriting the previous BFD-RS set at 610. In some aspects, 806 may be performed by update component 198.

At 808, the UE may transmit, to the network entity based on receiving the second MAC-CE, an ACK. For example, the UE 602 may transmit, to the network entity 604 based on receiving the second MAC-CE 608, an ACK 609. In some aspects, 808 may be performed by update component 198.

At 810, the UE may apply, after a time period following transmission of the ACK, the second set of BFD RS. For example, the UE 602 may apply, after a time period following transmission of the ACK 609, the second set of BFD RS. In some aspects, 810 may be performed by update component 198.

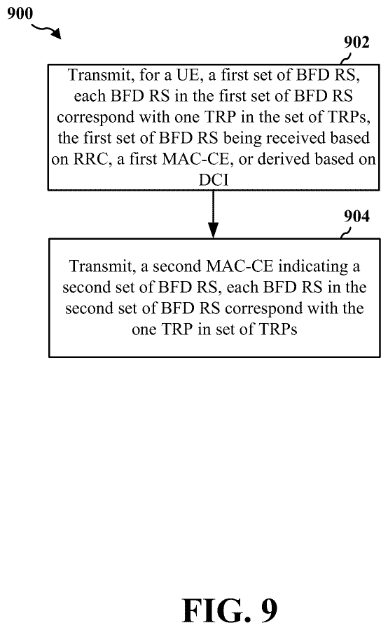

FIG. 9 is a flowchart 900 of a method of wireless communication. The method may be performed by a network entity (e.g., the base station 102; the network entity 604, the network entity 1002, a component of the network entity 1102).

At 902, the network entity may transmit, for a UE, a first set of BFD RS, each BFD RS in the first set of BFD RS correspond with one TRP in the set of TRPs, the first set of BFD RS may be received based on RRC, a first MAC-CE, or derived based on DCI. For example, the network entity 604 may transmit, for a UE 602, a first set of BFD RS 606, each BFD RS in the first set of BFD RS correspond with one TRP in the set of TRPs, the first set of BFD RS may be received based on RRC, a first MAC-CE, or derived based on DCI.

At 904, the network entity may transmit, a second MAC-CE indicating a second set of BFD RS, each BFD RS in the second set of BFD RS correspond with the one TRP in set of TRPs. For example, the network entity 604 may transmit, a MAC-CE 608 indicating a second set of BFD RS, each BFD RS in the second set of BFD RS may correspond with the one TRP in set of TRPs. In some aspects, 904 may be performed by update component 199. In some aspects, the second MAC-CE is associated with a cell ID associated with the second set of BFD RS and a BWP ID. In some aspects, the second MAC-CE is associated with one or more BFR RS set IDs. In some aspects, the second MAC-CE further indicates at least one of a cell ID or a BWP ID for each BFD RS in the second set of BFD RS. In some aspects, the second MAC-CE further indicates a local resource ID from a configured BFD RS pool as BFD RS ID for each BFD RS in the second set of BFD RS. In some aspects, the second MAC-CE is associated with multiple cells associated with the network entity. In some aspects, the second MAC-CE further indicates that the second set of BFD RS is associated with a one cell in the multiple cells associated with the network entity. In some aspects, the second MAC-CE is associated with a single cell associated with the network entity. In some aspects, the second MAC-CE is associated with a candidate RS set indication representing a candidate RS set associated with the second set of BFD RS or one or more candidate RS IDs, the candidate RS set indication being included in the second MAC-CE or a third MAC-CE. In some aspects, the second MAC-CE is associated with a candidate RS indication representing whether each candidate RS in a set of candidate RS is a channel status information (CSI) reference signal (CSI RS) or a synchronization signal block (SSB) or representing candidate RS ID associated with each candidate RS in the set of candidate RS, the candidate RS indication being included in the second MAC-CE or a third MAC-CE. In some aspects, the second MAC-CE further indicates an existence of a candidate RS set associated with a cell associated with the second set of BED RS.

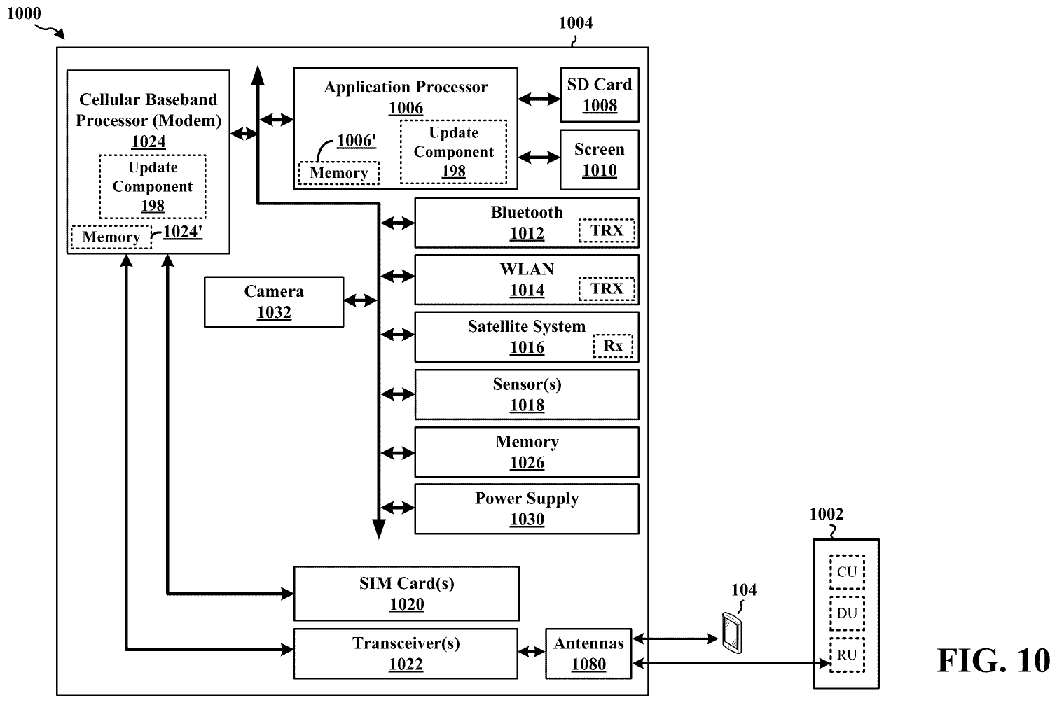

FIG. 10 is a diagram 1000 illustrating an example of a hardware implementation for an apparatus 1004. The apparatus 1004 may be a UE, a component of a UE, or may implement UE functionality. In some aspects, the apparatus 1004 may include a cellular baseband processor 1024 (also referred to as a modem) coupled to one or more transceivers 1022 (e.g., cellular RF transceiver). The cellular baseband processor 1024 may include on-chip memory 1024′. In some aspects, the apparatus 1004 may further include one or more subscriber identity modules (SIM) cards 1020 and an application processor 1006 coupled to a secure digital (SD) card 1008 and a screen 1010. The application processor 1006 may include on-chip memory 1006′. In some aspects, the apparatus 1004 may further include a Bluetooth module 1012, a WLAN module 1014, a satellite system module 1016 (e.g., GNSS module), one or more sensor modules 1018 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1026, a power supply 1030, and/or a camera 1032. The Bluetooth module 1012, the WLAN module 1014, and the satellite system module 1016 may include an on-chip transceiver (TRX)/receiver (RX). The cellular baseband processor 1024 communicates through the transceiver(s) 1022 via one or more antennas 1080 with the UE 104 and/or with an RU associated with a network entity 1002. The cellular baseband processor 1024 and the application processor 1006 may each include a computer-readable medium/memory 1024′, 1006′, respectively. The additional memory modules 1026 may also be considered a computer-readable medium/memory. Each computer-readable medium/memory 1024′, 1006′, 1026 may be non-transitory. The cellular baseband processor 1024 and the application processor 1006 are each responsible for general processing, including the execution of software stored on the computer-readable medium/memory. The software, when executed by the cellular baseband processor 1024/application processor 1006, causes the cellular baseband processor 1024/application processor 1006 to perform the various functions described supra. The computer-readable medium/memory may also be used for storing data that is manipulated by the cellular baseband processor 1024/application processor 1006 when executing software. The cellular baseband processor 1024/application processor 1006 may be a component of the UE 350 and may include the memory 360 and/or at least one of the TX processor 368, the RX processor 356, and the controller/processor 359. In one configuration, the apparatus 1004 may be a processor chip (modem and/or application) and include just the cellular baseband processor 1024 and/or the application processor 1006, and in another configuration, the apparatus 1004 may be the entire UE (e.g., see 350 of FIG. 3) and include the additional modules of the apparatus 1004.

As discussed supra, the update component 198 may be configured to receive, from a network entity associated with a set of TRPs, a first set of BFD RS, each BFD RS in the first set of BFD RS correspond with one TRP in the set of TRPs, the first set of BFD RS being received based on RRC, a first MAC-CE, or derived based on DCI. In some aspects, the update component 198 may be further configured to receive, from the network entity, a second MAC-CE indicating a second set of BFD RS, each BFD RS in the second set of BFD RS correspond with the one TRP in set of TRPs. The update component 198 may be within the cellular baseband processor 1024, the application processor 1006, or both the cellular baseband processor 1024 and the application processor 1006. The update component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1004 may include a variety of components configured for various functions. In one configuration, the apparatus 1004, and in particular the cellular baseband processor 1024 and/or the application processor 1006, includes means for receiving, from a network entity associated with a set of TRPs, a first set of BFD RS, each BFD RS in the first set of BFD RS correspond with one TRP in the set of TRPs, the first set of BFD RS being received based on RRC, a first MAC-CE, or derived based on DCI. In some aspects, the apparatus 1004 may further include means for receiving, from the network entity, a second MAC-CE indicating a second set of BFD RS, each BFD RS in the second set of BFD RS correspond with the one TRP in set of TRPs. In some aspects, the apparatus 1004 may further include means for monitoring for the second set of BFD RS instead of the first set of BFD RS in response to reception of the second MAC-CE. In some aspects, the apparatus 1004 may further include means for transmitting, to the network entity based on receiving the second MAC-CE, an ACK. In some aspects, the apparatus 1004 may further include means for applying, after a time period following transmission of the ACK, the second set of BFD RS. The means may be the update component 198 of the apparatus 1004 configured to perform the functions recited by the means. As described supra, the apparatus 1004 may include the TX processor 368, the RX processor 356, and the controller/processor 359. As such, in one configuration, the means may be the TX processor 368, the RX processor 356, and/or the controller/processor 359 configured to perform the functions recited by the means.

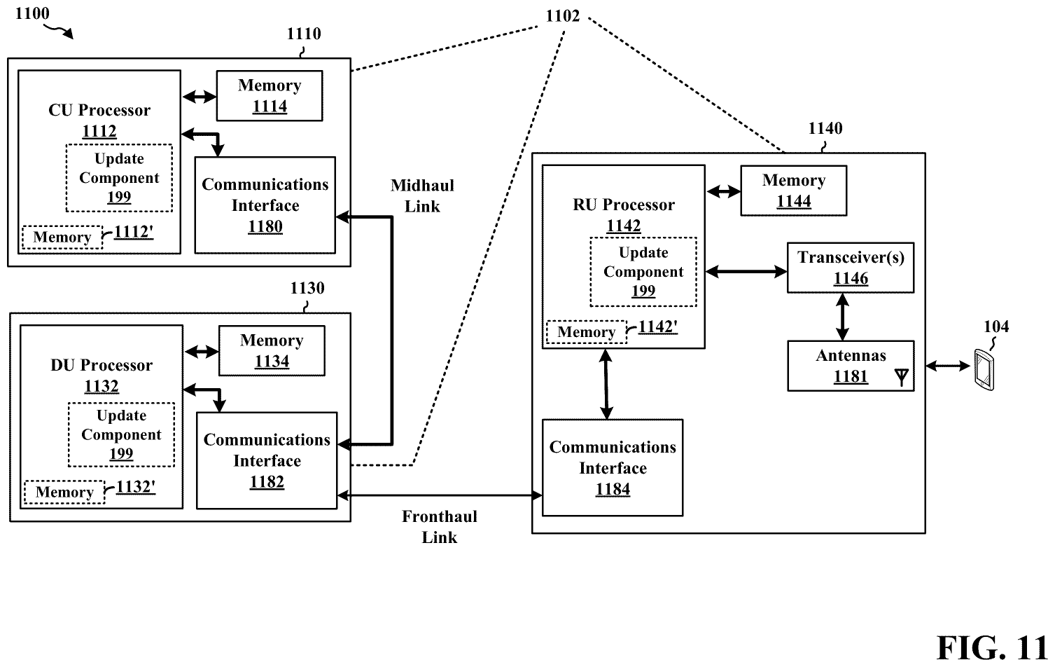

FIG. 11 is a diagram 1100 illustrating an example of a hardware implementation for a network entity 1102. The network entity 1102 may be a BS, a component of a BS, or may implement BS functionality. The network entity 1102 may include at least one of a CU 1110, a DU 1130, or an RU 1140. For example, depending on the layer functionality handled by the component 199, the network entity 1102 may include the CU 1110; both the CU 1110 and the DU 1130; each of the CU 1110, the DU 1130, and the RU 1140; the DU 1130; both the DU 1130 and the RU 1140; or the RU 1140. The CU 1110 may include a CU processor 1112. The CU processor 1112 may include on-chip memory 1112′. In some aspects, the CU 1110 may further include additional memory modules 1114 and a communications interface 1180. The CU 1110 communicates with the DU 1130 through a midhaul link, such as an F1 interface. The DU 1130 may include a DU processor 1132. The DU processor 1132 may include on-chip memory 1132′. In some aspects, the DU 1130 may further include additional memory modules 1134 and a communications interface 1182. The DU 1130 communicates with the RU 1140 through a fronthaul link. The RU 1140 may include an RU processor 1142. The RU processor 1142 may include on-chip memory 1142′. In some aspects, the RU 1140 may further include additional memory modules 1144, one or more transceivers 1146, antennas 1181, and a communications interface 1184. The RU 1140 communicates with the UE 104. The on-chip memory 1112′, 1132′, 1142′ and the additional memory modules 1114, 1134, 1144 may each be considered a computer-readable medium/memory. Each computer-readable medium/memory may be non-transitory. Each of the processors 1112, 1132, 1142 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 is configured to transmit, for a UE, a first set of BFD RS, each BFD RS in the first set of BFD RS correspond with one TRP in the set of TRPs, the first set of BFD RS being received based on RRC, a first MAC-CE, or derived based on DCI. In some aspects, the update component 199 may be further configured to transmit, a second MAC-CE indicating a second set of BFD RS, each BFD RS in the second set of BFD RS correspond with the one TRP in set of TRPs. The component 199 may be within one or more processors of one or more of the CU 1110, DU 1130, and the RU 1140. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1102 may include a variety of components configured for various functions. In one configuration, the network entity 1102 includes means for transmitting, for a UE, a first set of BFD RS, each BFD RS in the first set of BFD RS correspond with one TRP in the set of TRPs, the first set of BFD RS being received based on RRC, a first MAC-CE, or derived based on DCI. In some aspects, the network entity 1102 may further include means for transmitting, a second MAC-CE indicating a second set of BFD RS, each BFD RS in the second set of BFD RS correspond with the one TRP in set of TRPs. The means may be the update component 199 of the network entity 1102 configured to perform the functions recited by the means. As described supra, the network entity 1102 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used in this disclosure outside of the claims, the phrase “based on” is inclusive of all interpretations and shall not be limited to any single interpretation unless specifically recited or indicated as such. For example, the phrase “based on A” (where “A” may be information, a condition, a factor, or the like) may be interpreted as: “based at least on A,” “based in part on A,” “based at least in part on A,” “based only on A,” or “based solely on A.” Accordingly, as disclosed herein, “based on A” may, in one aspect, refer to “based at least on A.” In another aspect, “based on A” may refer to “based in part on A.” In another aspect, “based on A” may refer to “based at least in part on A.” In another aspect, “based on A” may refer to “based only on A.” In another aspect, “based on A” may refer to “based solely on A.” In another aspect, “based on A” may refer to any combination of interpretations in the alternative. As used in the claims, the phrase “based on A” shall be interpreted as “based at least on A” unless specifically recited differently.

The following aspects are illustrative only and may be combined with other aspects or teachings described herein, without limitation.

Aspect 1 is a method for communication at a user equipment (UE), comprising: receiving, from a network entity associated with a set of transmission reception points (TRPs), a first set of beam failure detection (BFD) reference signal (RS) (BFD RS), each BFD RS in the first set of BFD RS correspond with one TRP in the set of TRPs, the first set of BFD RS being received based on radio resource control (RRC), a first medium access control (MAC) control element (MAC-CE), or derived based on downlink control information (DCI); and receiving, from the network entity, a second MAC-CE indicating a second set of BFD RS, each BFD RS in the second set of BFD RS correspond with the one TRP in set of TRPs.

Aspect 2 is the method of aspect 1, where the second MAC-CE is associated with a cell identifier (ID) associated with the second set of BFD RS and a bandwidth part (BWP) ID.

Aspect 3 is the method of any of aspects 1-2, where the second MAC-CE is associated with one or more beam failure recovery (BFR) RS set identifiers (IDs).

Aspect 4 is the method of any of aspects 1-3, where the second MAC-CE further indicates at least one of a cell ID or a bandwidth part (BWP) ID for each BFD RS in the second set of BFD RS.

Aspect 5 is the method of any of aspects 1-4, where the second MAC-CE further indicates a local resource identifier (ID) from a configured BFD RS pool as BFD RS ID for each BFD RS in the second set of BFD RS.

Aspect 6 is the method of any of aspects 1-5, further comprising: monitoring for the second set of BFD RS instead of the first set of BFD RS in response to reception of the second MAC-CE.

Aspect 7 is the method of any of aspects 1-6, further comprising: transmitting, to the network entity based on receiving the second MAC-CE, an acknowledgment (ACK); and applying, after a time period following transmission of the ACK, the second set of BFD RS.

Aspect 8 is the method of any of aspects 1-7, where the second MAC-CE is associated with multiple cells associated with the network entity.

Aspect 9 is the method of aspect 1-8, where the second MAC-CE further indicates that the second set of BFD RS is associated with a one cell in the multiple cells associated with the network entity.

Aspect 10 is the method of any of aspects 1-9, where the second MAC-CE is associated with a single cell associated with the network entity.

Aspect 11 is the method of any of aspects 1-10, where the second MAC-CE is associated with a candidate RS set indication representing a candidate RS set associated with the second set of BFD RS or one or more candidate RS identifiers (IDs), the candidate RS set indication being included in the second MAC-CE or a third MAC-CE.

Aspect 12 is the method of any of aspects 1-11, where the second MAC-CE is associated with a candidate RS indication representing whether each candidate RS in a set of candidate RS is a channel status information (CSI) reference signal (CSI RS) or a synchronization signal block (SSB) or representing candidate RS identifier (ID) associated with each candidate RS in the set of candidate RS, the candidate RS indication being included in the second MAC-CE or a third MAC-CE.

Aspect 13 is the method of any of aspects 1-12, where the second MAC-CE further indicates an existence of a candidate RS set associated with a cell associated with the second set of BFD RS.

Aspect 14 is a method for communication at a network entity associated with a set of transmission reception points (TRPs), comprising: transmitting, for a user equipment (UE), a first set of beam failure detection (BFD) reference signal (RS) (BFD RS), each BFD RS in the first set of BFD RS correspond with one TRP in the set of TRPs, the first set of BFD RS being received based on radio resource control (RRC), a first medium access control (MAC) control element (MAC-CE), or derived based on downlink control information (DCI); and transmitting, a second MAC-CE indicating a second set of BFD RS, each BFD RS in the second set of BFD RS correspond with the one TRP in set of TRPs.

Aspect 15 is the method of aspect 14, where the second MAC-CE is associated with a cell identifier (ID) associated with the second set of BFD RS and a bandwidth part (BWP) ID.

Aspect 16 is the method of any of aspects 14-15, where the second MAC-CE is associated with one or more beam failure recovery (BFR) RS set identifiers (IDs).

Aspect 17 is the method of any of aspects 14-16, where the second MAC-CE further indicates at least one of a cell ID or a bandwidth part (BWP) ID for each BFD RS in the second set of BFD RS.

Aspect 18 is the method of any of aspects 14-17, where the second MAC-CE further indicates a local resource identifier (ID) from a configured BFD RS pool as BFD RS ID for each BFD RS in the second set of BFD RS.

Aspect 19 is the method of any of aspects 14-18, where the second MAC-CE is associated with multiple cells associated with the network entity.

Aspect 20 is the method of any of aspects 14-19, where the second MAC-CE further indicates that the second set of BFD RS is associated with a one cell in the multiple cells associated with the network entity.

Aspect 21 is the method of any of aspects 14-20, where the second MAC-CE is associated with a single cell associated with the network entity.

Aspect 22 is the method of any of aspects 14-21, where the second MAC-CE is associated with a candidate RS set indication representing a candidate RS set associated with the second set of BFD RS or one or more candidate RS identifiers (IDs), the candidate RS set indication being included in the second MAC-CE or a third MAC-CE.

Aspect 23 is the method of any of aspects 14-22, where the second MAC-CE is associated with a candidate RS indication representing whether each candidate RS in a set of candidate RS is a channel status information (CSI) reference signal (CSI RS) or a synchronization signal block (SSB) or representing candidate RS identifier (ID) associated with each candidate RS in the set of candidate RS, the candidate RS indication being included in the second MAC-CE or a third MAC-CE.

Aspect 24 is the method of any of aspects 14-23, where the second MAC-CE further indicates an existence of a candidate RS set associated with a cell associated with the second set of BFD RS.

Aspect 25 is an apparatus for wireless communication at a UE including a memory and at least one processor coupled to the memory and, based at least in part on information stored in the memory, configured to perform a method in accordance with any of aspects 1-13. The apparatus may include at least one of a transceiver or an antenna coupled to the at least one processor.

Aspect 27 is an apparatus for wireless communications, including means for performing a method in accordance with any of aspects 1-13.

Aspect 27 is a non-transitory computer-readable medium including instructions that, when executed by an apparatus, cause the apparatus to perform a method in accordance with any of aspects 1-13.

Aspect 28 is an apparatus for wireless communication at a network entity including a memory and at least one processor coupled to the memory and, based at least in part on information stored in the memory, configured to perform a method in accordance with any of aspects 14-24. The apparatus may include at least one of a transceiver or an antenna coupled to the at least one processor.

Aspect 29 is an apparatus for wireless communications, including means for performing a method in accordance with any of aspects 14-24.

Aspect 30 is a non-transitory computer-readable medium including instructions that, when executed by an apparatus, cause the apparatus to perform a method in accordance with any of aspects 14-24.

What is claimed is:

1. An apparatus for communication at a user equipment (UE), comprising:
memory; and
at least one processor coupled to the memory and, based at least in part on information stored in the memory, the at least one processor is configured to:
receive, from a network entity associated with a set of transmission reception points (TRPs), a first set of beam failure detection (BFD) reference signal (RS) (BFD RS), each BFD RS in the first set of BFD RS correspond with one TRP in the set of TRPs, the first set of BFD RS being received based on radio resource control (RRC), a first medium access control (MAC) control element (MAC-CE), or derived based on downlink control information (DCI); and
receive, from the network entity, a second MAC-CE indicating a second set of BFD RS, each BFD RS in the second set of BFD RS correspond with the one TRP in set of TRPs.

2. The apparatus of claim 1, wherein the second MAC-CE is associated with a cell identifier (ID) associated with the second set of BFD RS and a bandwidth part (BWP) ID.

3. The apparatus of claim 1, wherein the second MAC-CE is associated with one or more beam failure recovery (BFR) RS set identifiers (IDs).

4. The apparatus of claim 1, wherein the second MAC-CE further indicates at least one of a cell ID or a bandwidth part (BWP) ID for each BFD RS in the second set of BFD RS.

5. The apparatus of claim 1, wherein the second MAC-CE further indicates a local resource identifier (ID) from a configured BFD RS pool as BFD RS ID for each BFD RS in the second set of BFD RS.

6. The apparatus of claim 1, wherein the at least one processor is configured to:
monitor for the second set of BFD RS instead of the first set of BFD RS in response to reception of the second MAC-CE.

7. The apparatus of claim 1, wherein the at least one processor is configured to:
transmit, to the network entity based on receiving the second MAC-CE, an acknowledgment (ACK); and
apply, after a time period following transmission of the ACK, the second set of BFD RS.

8. The apparatus of claim 1, wherein the second MAC-CE is associated with multiple cells associated with the network entity.

9. The apparatus of claim 8, wherein the second MAC-CE further indicates that the second set of BFD RS is associated with a one cell in the multiple cells associated with the network entity.

10. The apparatus of claim 1, wherein the second MAC-CE is associated with a single cell associated with the network entity.

11. The apparatus of claim 1, wherein the second MAC-CE is associated with a candidate RS set indication representing a candidate RS set associated with the second set of BFD RS or one or more candidate RS identifiers (IDs), the candidate RS set indication being included in the second MAC-CE or a third MAC-CE.

12. The apparatus of claim 1, wherein the second MAC-CE is associated with a candidate RS indication representing whether each candidate RS in a set of candidate RS is a channel status information (CSI) reference signal (CSI RS) or a synchronization signal block (SSB) or representing candidate RS identifier (ID) associated with each candidate RS in the set of candidate RS, the candidate RS indication being included in the second MAC-CE or a third MAC-CE.

13. The apparatus of claim 1, wherein the second MAC-CE further indicates an existence of a candidate RS set associated with a cell associated with the second set of BFD RS.

14. The apparatus of claim 1, further comprising at least one of a transceiver or an antenna coupled to the at least one processor.

15. An apparatus for communication at a network entity associated with a set of transmission reception points (TRPs), comprising:
memory; and
at least one processor coupled to the memory and, based at least in part on information stored in the memory, the at least one processor is configured to:
transmit, for a user equipment (UE), a first set of beam failure detection (BFD) reference signal (RS) (BFD RS), each BFD RS in the first set of BFD RS correspond with one TRP in the set of TRPs, the first set of BFD RS being received based on radio resource control (RRC), a first medium access control (MAC) control element (MAC-CE), or derived based on downlink control information (DCI); and
transmit, a second MAC-CE indicating a second set of BFD RS, each BFD RS in the second set of BFD RS correspond with the one TRP in set of TRPs.

16. The apparatus of claim 15, wherein the second MAC-CE is associated with a cell identifier (ID) associated with the second set of BFD RS and a bandwidth part (BWP) ID.

17. The apparatus of claim 15, wherein the second MAC-CE is associated with one or more beam failure recovery (BFR) RS set identifiers (IDs).

18. The apparatus of claim 15, wherein the second MAC-CE further indicates at least one of a cell ID or a bandwidth part (BWP) ID for each BFD RS in the second set of BFD RS.

19. The apparatus of claim 15, wherein the second MAC-CE further indicates a local resource identifier (ID) from a configured BFD RS pool as BFD RS ID for each BFD RS in the second set of BFD RS.

20. The apparatus of claim 15, wherein the second MAC-CE is associated with multiple cells associated with the network entity.

21. The apparatus of claim 20, wherein the second MAC-CE further indicates that the second set of BFD RS is associated with a one cell in the multiple cells associated with the network entity.

22. The apparatus of claim 15, wherein the second MAC-CE is associated with a single cell associated with the network entity.

23. The apparatus of claim 15, wherein the second MAC-CE is associated with a candidate RS set indication representing a candidate RS set associated with the second set of BFD RS or one or more candidate RS identifiers (IDs), the candidate RS set indication being included in the second MAC-CE or a third MAC-CE.

24. The apparatus of claim 15, wherein the second MAC-CE is associated with a candidate RS indication representing whether each candidate RS in a set of candidate RS is a channel status information (CSI) reference signal (CSI RS) or a synchronization signal block (SSB) or representing candidate RS identifier (ID) associated with each candidate RS in the set of candidate RS, the candidate RS indication being included in the second MAC-CE or a third MAC-CE.

25. The apparatus of claim 15, wherein the second MAC-CE further indicates an existence of a candidate RS set associated with a cell associated with the second set of BFD RS.

26. The apparatus of claim 15, further comprising at least one of a transceiver or an antenna coupled to the at least one processor.

27. A method for communication at a user equipment (UE), comprising:
receiving, from a network entity associated with a set of transmission reception points (TRPs), a first set of beam failure detection (BFD) reference signal (RS) (BFD RS), each BFD RS in the first set of BFD RS correspond with one TRP in the set of TRPs, the first set of BFD RS being received based on radio resource control (RRC), a first medium access control (MAC) control element (MAC-CE), or derived based on downlink control information (DCI); and
receiving, from the network entity, a second MAC-CE indicating a second set of BFD RS, each BFD RS in the second set of BFD RS correspond with the one TRP in set of TRPs.

28. The method of claim 27, wherein the second MAC-CE is associated with a cell identifier (ID) associated with the second set of BFD RS and a bandwidth part (BWP) ID.

29. The method of claim 27, wherein the second MAC-CE is associated with one or more beam failure recovery (BFR) RS set identifiers (IDs).

30. A method for communication at a network entity associated with a set of transmission reception points (TRPs), comprising:
transmitting, for a user equipment (UE), a first set of beam failure detection (BFD) reference signal (RS) (BFD RS), each BFD RS in the first set of BFD RS correspond with one TRP in the set of TRPs, the first set of BFD RS being received based on radio resource control (RRC), a first medium access control (MAC) control element (MAC-CE), or derived based on downlink control information (DCI); and
transmitting, a second MAC-CE indicating a second set of BFD RS, each BFD RS in the second set of BFD RS correspond with the one TRP in set of TRPs.
